(19) United States
(12) Patent Application Publication
(10) Pub. No.: US 2016/0219066 A1
(43) Pub. Date: Jul. 28, 2016

(54) EVENT CORRELATION IN A NETWORK MERGING LOCAL GRAPH MODELS FROM DISTRIBUTED NODES

(71) Applicant: Cisco Technology, Inc., San Jose, CA (US)

(72) Inventors: Jean-Philippe Vasseur, Saint Martin d'Uriage (FR); Grégory Mermoud, Veyras (CH); Javier Cruz Mota, Assens (CH)

(21) Appl. No.: 14/605,916

(22) Filed: Jan. 26, 2015

(51) Int. Cl. H04L 29/06

(52) U.S. Cl. CPC H04L 63/1425; H04L 63/1416; H04L 63/1458

(57) ABSTRACT

In one embodiment, a device in a network receives an indication of a network anomaly detected by a first graph-based anomaly detection model hosted by a first node in the network. The device identifies one or more additional graph-based anomaly detection models based on the network anomaly detected by the first graph-based anomaly detection model. The device correlates one or more network events from the one or more additional graph-based anomaly detection models with the network anomaly detected by the first graph-based anomaly detection model. The device identifies a cause of the network anomaly using the one or more network events from the one or more additional graph-based anomaly detection models that are correlated with the network anomaly detected by the first graph-based anomaly detection model.

### TECHNICAL FIELD

The present disclosure relates generally to computer networks, and, more particularly, to correlating network events by correlating local graph models from distributed nodes in the network.

### BACKGROUND

One type of network attack that is of particular concern in the context of computer networks is a Denial of Service (DoS) attack. In general, the goal of a DoS attack is to prevent legitimate use of the services available on the network. For example, a DoS jamming attack may artificially introduce interference into the network, thereby causing collisions with legitimate traffic and preventing message decoding. In another example, a DoS attack may attempt to overwhelm the network's resources by flooding the network with requests, to prevent legitimate requests from being processed. A DoS attack may also be distributed, to conceal the presence of the attack. For example, a distributed DoS (DDoS) attack may involve multiple attackers sending malicious requests, making it more difficult to distinguish when an attack is underway. When viewed in isolation, a particular one of such a request may not appear to be malicious. However, in the aggregate, the requests may overload a resource, thereby impacting legitimate requests sent to the resource.

Botnets represent one way in which a DDoS attack may be launched against a network. In a botnet, a subset of the network devices may be infected with malicious software, thereby allowing the devices in the botnet to be controlled by a single master. Using this control, the master can then coordinate the attack against a given network resource.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3A illustrates an example graph-based model;

FIG. 3B illustrates an example of graph-based models being correlated;

FIGS. 4A-4G illustrates an example architecture for detecting a network anomaly;

FIG. 5 illustrates an example simplified procedure for identifying the cause of a network anomaly using graph-based anomaly detection models; and

FIG. 6 illustrates an example simplified procedure for using a graph-based anomaly detection model.

### DESCRIPTION OF EXAMPLE EMBODIMENTS

### Overview

According to one or more embodiments of the disclosure, a device in a network receives an indication of a network anomaly detected by a first graph-based anomaly detection model hosted by a first node in the network. The device identifies one or more additional graph-based anomaly detection models based on the network anomaly detected by the first graph-based anomaly detection model. The device correlates one or more network events from the one or more additional graph-based anomaly detection models with the network anomaly detected by the first graph-based anomaly detection model. The device identifies a cause of the network anomaly using the one or more network events from the one or more additional graph-based anomaly detection models that are correlated with the network anomaly detected by the first graph-based anomaly detection model.

In further embodiments, a first device in a network maintains a graph-based anomaly detection model for a set of nodes in the network. The first device detects a network anomaly using the graph-based anomaly detection model. The first device reports the detected network anomaly to a second device. The first device provides data regarding the graph-based anomaly detection model for the set of nodes to the second device.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

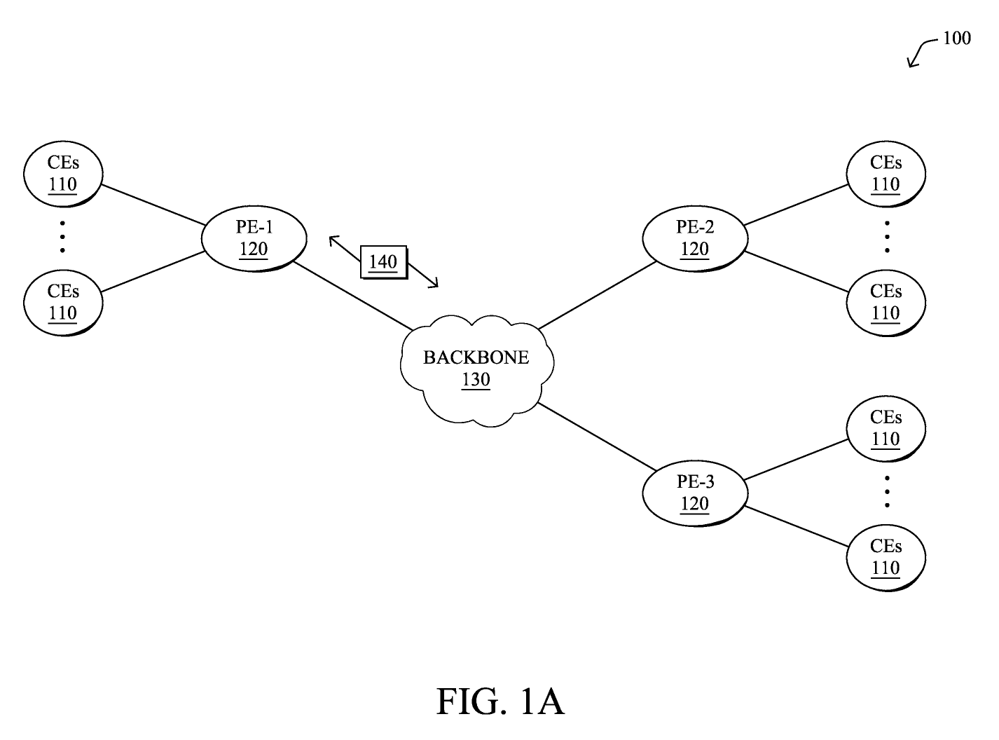

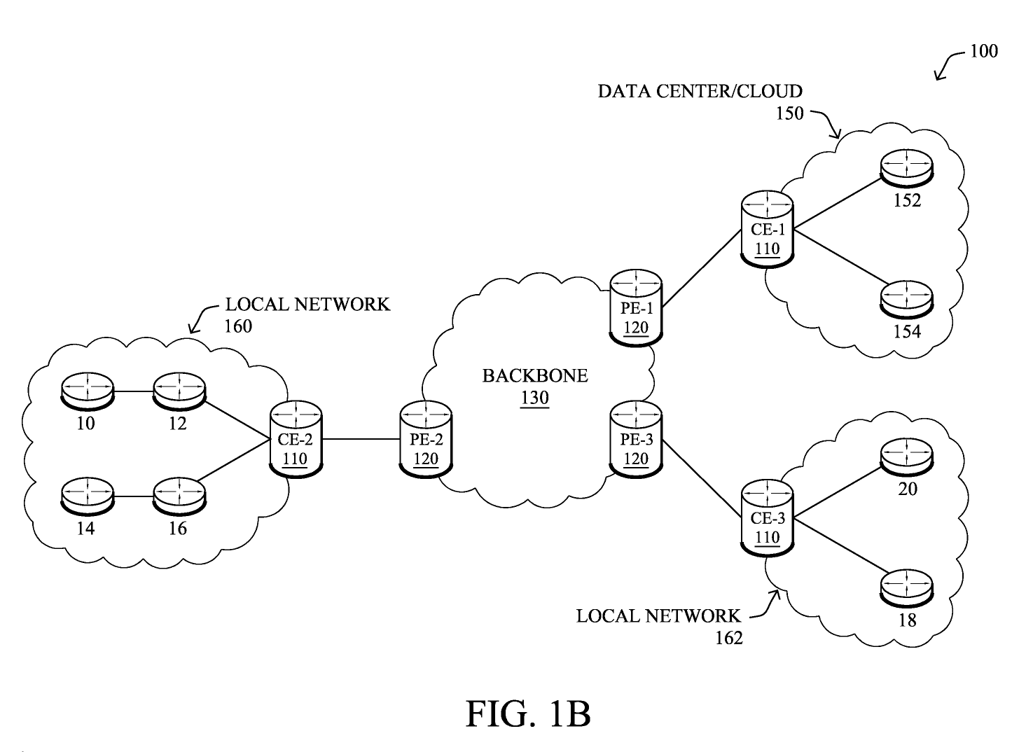

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement (SLA) characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/LTE connection). A site of type B may itself be of different types:

2a.) Site Type B1: a site connected to the network using two MPLS VPN links (e.g., from different Service Providers), with potentially a backup link (e.g., a 3G/4G/LTE connection).

2b.) Site Type B2: a site connected to the network using one MPLS VPN link and one link connected to the public Internet, with potentially a backup link (e.g., a 3G/4G/LTE connection). For example, a particular customer site may be connected to network 100 via PE-3 and via a separate Internet connection, potentially also with a wireless backup link.

2c.) Site Type B3: a site connected to the network using two links connected to the public Internet, with potential a backup link (e.g., a 3G/4G/LTE connection).

Notably, MPLS VPN links are usually tied to a committed SLA, whereas Internet links may either have no SLA at all or a loose SLA (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may include local networks 160, 162 that include devices/nodes 10-16 and devices/nodes 18-20, respectively, as well as a data center/cloud environment 150 that includes servers 152-154. Notably, networks 160-162 and data center/cloud environment 150 may also be located in different geographic locations. Servers 152-154 may include, in various embodiments, a network management server (NMS), a dynamic host configuration protocol (DHCP) server, a constrained application protocol (CoAP) server, an outage management system (OMS), an application policy infrastructure controller (APIC), etc. As would be appreciated, network 100 may include any number of local networks, data centers, cloud environments, devices/nodes, servers, etc.

In some embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

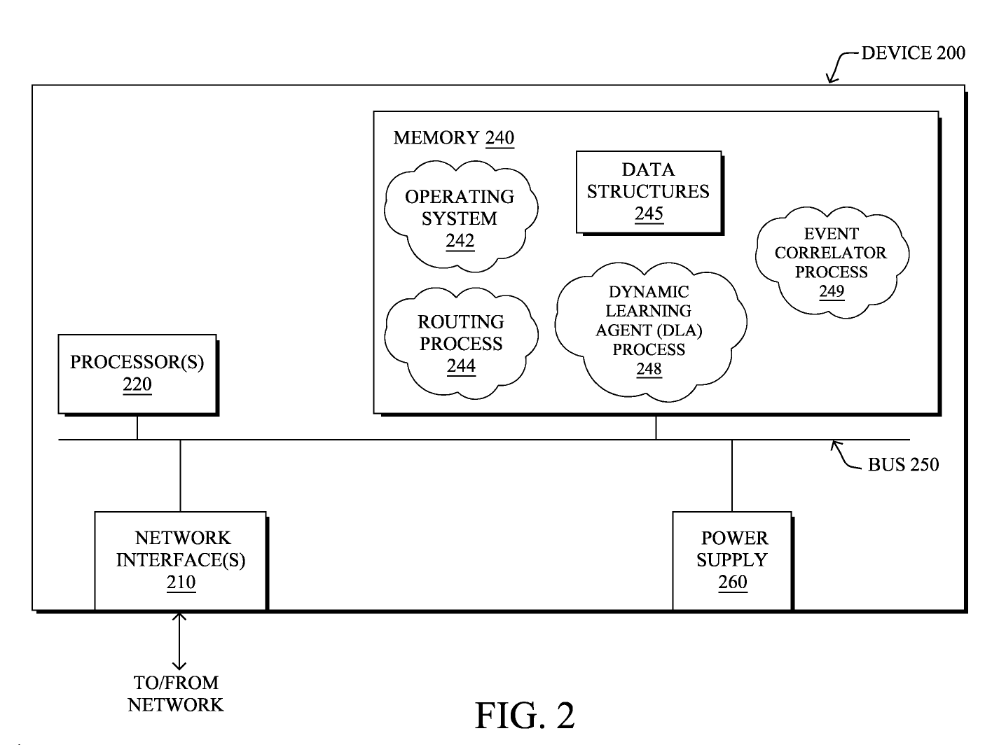

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), or any other computing device that supports the operations of network 100 (e.g., switches, etc.). The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise routing process 244 (e.g., routing services) and illustratively, a dynamic learning agent (DLA) process 248 and/or an event correlator process 249, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Routing process/services 244 include computer executable instructions executed by processor 220 to perform functions provided by one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP), etc., as will be understood by those skilled in the art. These functions may be configured to manage a forwarding information database including, e.g., data used to make forwarding decisions. In particular, changes in the network topology may be communicated among routers 200 using routing protocols, such as the conventional OSPF and IS-IS link-state protocols (e.g., to “converge” to an identical view of the network topology).

Notably, routing process 244 may also perform functions related to virtual routing protocols, such as maintaining VRF instance, or tunneling protocols, such as for MPLS, generalized MPLS (GMPLS), etc., each as will be understood by those skilled in the art. Also, EVPN, e.g., as described in the IETF Internet Draft entitled “BGP MPLS Based Ethernet VPN”<draft-ietf-12vpn-evpn>, introduce a solution for multipoint L2VPN services, with advanced multi-homing capabilities, using BGP for distributing customer/client media access control (MAC) address reach-ability information over the core MPLS/IP network.

DLA process 248 and/or event correlator process 249 include computer executable instructions that, when executed by processor(s) 220, cause device 200 to perform anomaly detection functions as part of an anomaly detection infrastructure within the network. In general, anomaly detection attempts to identify patterns that do not conform to an expected behavior. For example, in one embodiment, the anomaly detection infrastructure of the network may be operable to detect network attacks (e.g., DDoS attacks, the use of malware such as viruses, rootkits, etc.). However, anomaly detection in the context of computer networking typically presents a number of challenges: 1.) a lack of a ground truth (e.g., examples of normal vs. abnormal network behavior), 2.) being able to define a “normal” region in a highly dimensional space can be challenging, 3.) the dynamic nature of the problem due to changing network behaviors/anomalies, 4.) malicious behaviors such as malware, viruses, rootkits, etc. may adapt in order to appear “normal,” and 5.) differentiating between noise and relevant anomalies is not necessarily possible from a statistical standpoint, but typically also requires domain knowledge.

Anomalies may also take a number of forms in a computer network: 1.) point anomalies (e.g., a specific data point is abnormal compared to other data points), 2.) contextual anomalies (e.g., a data point is abnormal in a specific context but not when taken individually), or 3.) collective anomalies (e.g., a collection of data points is abnormal with regards to an entire set of data points).

In various embodiments, processes 248-249 may utilize machine learning techniques, to perform anomaly detection in the network. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

Computational entities that rely on one or more machine learning techniques to perform a task for which they have not been explicitly programmed to perform are typically referred to as learning machines. In particular, learning machines are capable of adjusting their behavior to their environment. For example, a learning machine may dynamically make future predictions based on current or prior network measurements, may make control decisions based on the effects of prior control commands, etc.

For purposes of anomaly detection in a network, a learning machine may construct a model of normal network behavior, to detect data points that deviate from this model. For example, a given model (e.g., a supervised, un-supervised, or semi-supervised model) may be used to generate and report anomaly scores to another device. Example machine learning techniques that may be used to construct and analyze such a model may include, but are not limited to, nearest neighbor (NN) techniques (e.g., k-NN models, replicator NN models, etc.), statistical techniques (e.g., Bayesian networks, etc.), clustering techniques (e.g., k-means, etc.), neural networks (e.g., reservoir networks, artificial neural networks, etc.), support vector machines (SVMs), or the like.

One class of machine learning techniques that is of particular use in the context of anomaly detection is clustering. Generally speaking, clustering is a family of techniques that seek to group data according to some typically predefined notion of similarity. For instance, clustering is a very popular technique used in recommender systems for grouping objects that are similar in terms of people's taste (e.g., because you watched X, you may be interested in Y, etc.). Typical clustering algorithms are k-means, density based spatial clustering of applications with noise (DBSCAN) and mean-shift, where a distance to a cluster is computed with the hope of reflecting a degree of anomaly (e.g., using a Euclidian distance and a cluster based local outlier factor that takes into account the cluster density).

Replicator techniques may also be used for purposes of anomaly detection. Such techniques generally attempt to replicate an input in an unsupervised manner by projecting the data into a smaller space (e.g., compressing the space, thus performing some dimensionality reduction) and then reconstructing the original input, with the objective of keeping the “normal” pattern in the low dimensional space. Example techniques that fall into this category include principal component analysis (PCA) (e.g., for linear models), multi-layer perceptron (MLP) ANNs (e.g., for non-linear models), and replicating reservoir networks (e.g., for non-linear models, typically for time series).

According to various embodiments, processes 248-249 may use graph-based models for purposes of anomaly detection. Generally speaking, a graph-based model attempts to represent the relationships between different entities. For example, ego-centric graphs have been used to represent the relationship between a particular social networking profile and the other profiles connected to it (e.g., the connected “friends” of a user, etc.). The patterns of these connections can then be analyzed for purposes of anomaly detection. For example, in the social networking context, it may be considered anomalous for the connections of a particular profile not to share connections, as well. In other words, a person's social connections are typically also interconnected. If no such interconnections exist, this may be deemed anomalous.

In general, a graph is a mathematical structure that connects nodes using links that may or may not be weighted and/or directed. A typical graph used in networking is the directed graph generated by linking nodes that have performed a data communication. Thus, a graph-based anomaly detection model may construct such a graph and model and or all of the graph's parameters, to detect anomalies. For instance, the graph of communications between nodes in a network can be constructed and the amount of data transferred between two nodes may be used as the weight of its links. On this graph, a mixture of Gaussians model can be used, for instance, for modeling the amounts of transferred data between different nodes. This can then be used to detect anomalies in terms of transferred data, e.g., for detecting pairs of nodes that suddenly change their data communication behavior.

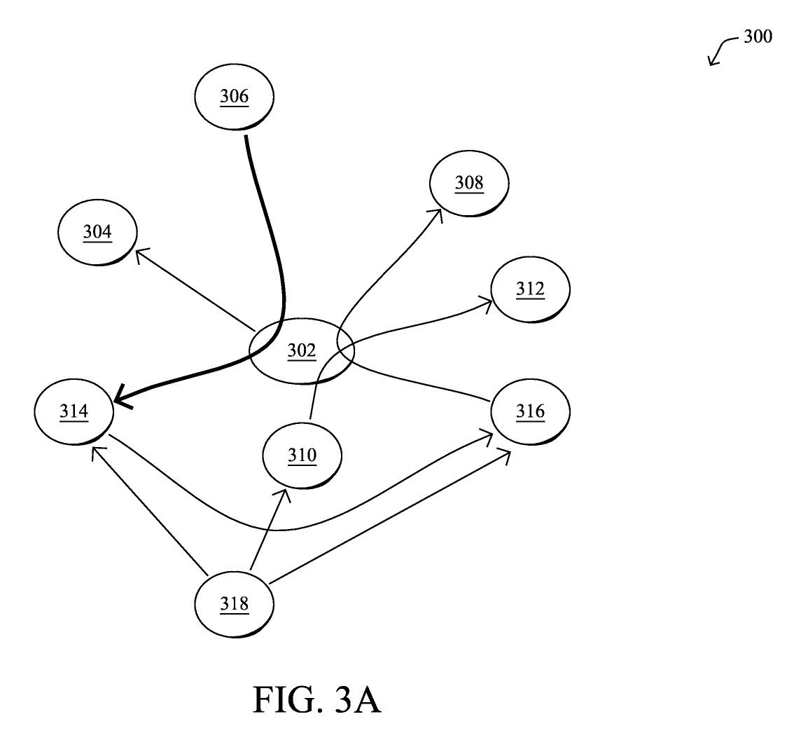

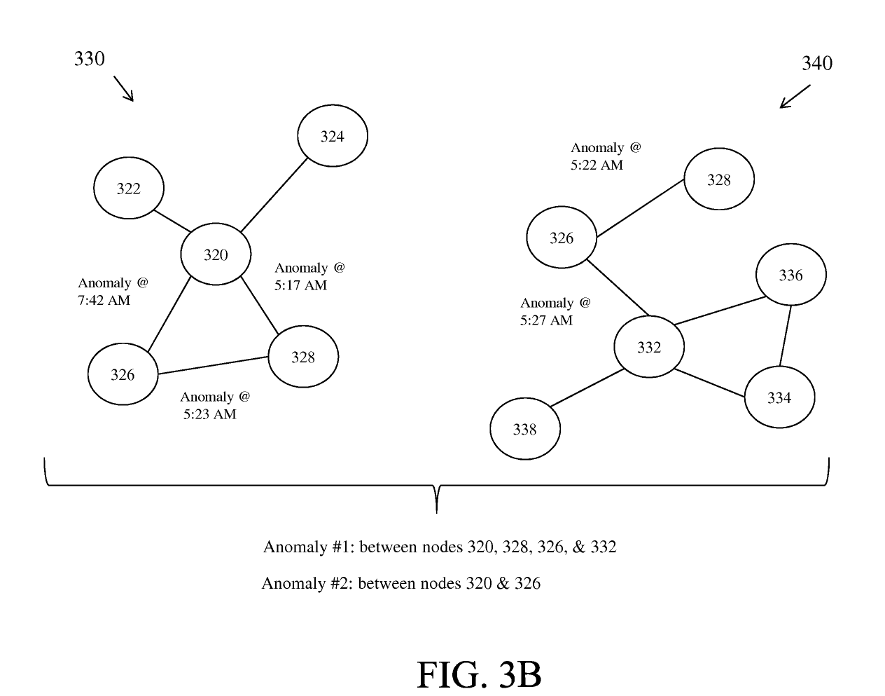

As shown in FIG. 3A, an example graph 300 is shown having nodes 302-318 that represent actual devices/nodes in the network. For example, assume that one of CE routers 110 is represented in graph-based model 300 as node 302. Edges between nodes 302-318 in graph-based model 300 may represent observed traffic flows between the nodes. For example, the network device represented as node 306 in model 300 may send traffic to the network device represented as node 314 in model 300 via the CE router 110 represented by node 302. In various embodiments, the edges in such a graph-based model may be directed, undirected, weighted (e.g., according to the volume of traffic, etc.), or unweighted. For example, node 306 may send a heavier amount of traffic to node 314 than node 318 sends to node 314. In further embodiments, the edges in such a graph-based model may aggregate the total traffic between devices/nodes or may be specific to one or more particular types of traffic flows (e.g., based on the application type, based on the type of message such as sending HTTP requests, etc.).

In various embodiments, events may be correlated across different graph-based models. For instance, the sequence of detected anomalies can be considered as a function of time and searched for anomalies that appear simultaneously on the network (e.g., those that have a high correlation in time). Notably, such anomalies may or may not occur in the same regions of the network. For example, a DDoS attack may involve a myriad of geographically-diverse devices launching an attack at a coordinated point in time. Another example of correlation can be a topological correlation using the graph information. For example, assume that two or more overlapping graph-based models (e.g., graphs having common nodes) each models the communications between their respective nodes. In such a case, an anomaly score may be computed for each link in terms of transferred data, etc., from the models. These anomaly scores may be topologically correlated, using the topological information provided by the different graph-based models, in order to correlate/associate anomalies that are related (e.g., an anomaly between nodes A and B detected on graph 1, between nodes B and C detected on graph 2, between C and D on graph 3, etc.). Note that combinations of different graph parameters may also be analyzed for purposes of anomaly detection. For example, temporal and topological correlations may be performed at the same time, in some embodiments.

FIG. 3B illustrates an example of graph-based models being correlated, according to various embodiments. As shown, assume that graph-based models 330 and 340 are constructed by different devices distributed throughout the network (e.g., devices executing DLA process 248). Assume, for example, that graph-based model 330 models the communications between the set of devices represented by nodes 320-328 and that graph-based model 340 models the communications between the set of devices represented by nodes 326-328 and nodes 332-338. In such a case, graph-based models 330 and 340 may be considered to be overlapping, since both include nodes 326-328. Each model may be used to detect anomalies based on one or more of their characteristics. In various embodiments, the graph topologies (e.g., which pairs of nodes are communicating, the directions of the communications, etc.), edge weights in the graph (e.g., the amount of data communicated between two nodes, the number of individual requests between two nodes, etc.), and/or temporal changes, may be used to identify anomalous conditions. As shown, for example, assume that an anomaly is detected from graph-based model 340 between nodes 326 and 332 at a certain time of day (e.g., at 5:27 AM) due to a sudden increase in traffic between the two nodes, traffic that previously didn't exist between the nodes, etc. Also as shown, other anomalies may be detected between node pairs {320, 326}, {320, 328}, and {326, 328}.

In various embodiments, events/anomalies between different graph-based models may be correlated (e.g., by event correlator process 249). For example, continuing the example of FIG. 3B, consider the anomalies detected via graph-based models 330 and 340 in the time domain. The anomalies detected between node pairs {320, 328} and {320, 328} from graph-based model 330 and between node pairs {326, 328} and {332, 326} from graph-based model 340 all occur within ten minutes of one another. In such a case, these anomalies may be associated with one another (e.g., the anomalies may be caused by the same coordinated attack, etc.). On the other hand, the anomaly detected between nodes 320 and 326 from graph-based model 330 may be uncorrelated temporally with the other anomalies shown and may be associated with a different cause than that of the other anomalies.

As noted previously, other anomaly detection techniques have been preferred in computer networks (e.g., to detect DDoS attacks, non-malicious code that is performing incorrectly, etc.) over that of graph-based anomaly detection models. Some approaches try to analyze changes in the overall statistical behavior of the network traffic (e.g., the traffic distribution among flows tends to flatten when a DDoS attack occurs). Other approaches aim at statistically characterizing the normal behaviors of network flows or TCP connections, in order to detect significant deviations. Classification approaches try to extract features of network flows and traffic that are characteristic of normal traffic or malicious traffic, constructing from these features a classifier that is able to differentiate between the two classes (normal and malicious).

Notably, graph-based anomaly detection models typically require that all information be available to the model. In the case of social networking, for example, this is not usually an issue, as all of the social networking information is available on the same system. However, in the context of modeling network behavior via distributed learning agents, it may be impractical for any particular device to have access to all information regarding the entire network.

Event Correlation Merging Local Graph Models from Distributed Nodes

The techniques herein provide an infrastructure that performs anomaly correlation by inspecting similarities between graph-based models computed by remote distributed learning agents. In some aspects, each remote distributed learning agent may be responsible for computing its own graph-based model that models a given subset of the network (e.g., the portion of the network of which a particular learning agent is able to observe). In further aspects, a supervisory (e.g., central) device may be operable to confirm an anomaly detected by a distributed agent (e.g., by seeking user input, based on defined rules, etc.), compute similarities between attacking flows detected by different graph-based models, determine the source/cause of an anomaly (e.g., how an attack is distributed), assess the degree of severity of an anomaly, and/or trigger a mitigation action to mitigate the effects of the detected anomaly or attack.

Illustratively, the techniques described herein may be performed by hardware, software, and/or firmware, such as in accordance with processes 248-249, which may include computer executable instructions executed by the processor 220 to perform functions relating to the techniques described herein. For example, the techniques herein may be treated as extensions to machine learning processes and protocols, and as such, may be processed by similar components understood in the art that execute those processes and protocols, accordingly.

Specifically, according to various embodiments, a device in a network receives an indication of a network anomaly detected by a first graph-based anomaly detection model hosted by a first node in the network. The device identifies one or more additional graph-based anomaly detection models based on the network anomaly detected by the first graph-based anomaly detection model. The device correlates one or more network events from the one or more additional graph-based anomaly detection models with the network anomaly detected by the first graph-based anomaly detection model. The device identifies a cause of the network anomaly using the one or more network events from the one or more additional graph-based anomaly detection models that are correlated with the network anomaly detected by the first graph-based anomaly detection model.

Operationally, the techniques herein introduce an infrastructure in which distributed devices in the network act as dynamic learning agents (DLAs) (e.g., by executing DLA process 248). Each DLA may build a partial view of the node-to-node relationships in the network. These relationships may be characterized by the amount of traffic exchanged by the nodes, the type of applications that communicate between these nodes, the geographical/topological proximity of the nodes, or any other information that may be used to characterize the nodes/devices. In many situations, such a partial view of the overall network may be sufficient for purposes of detecting network anomalies. For example, CE-2 and CE-3 shown in FIG. 1B may each execute DLA process 248 (e.g., to analyze the traffic associated with the devices in networks 160 and 162, respectively), to analyze their respective observation domains (ODs). Notably, a given ODᵢ may correspond to the set of nodes/devices whose flows are completely observed by a given DLAᵢ.

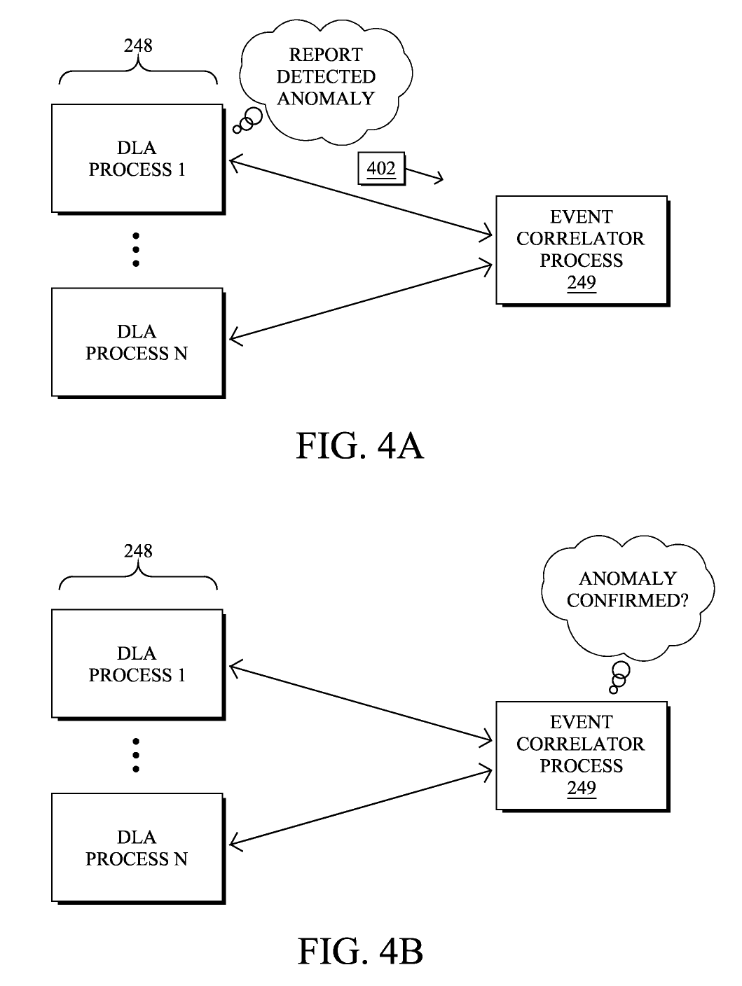

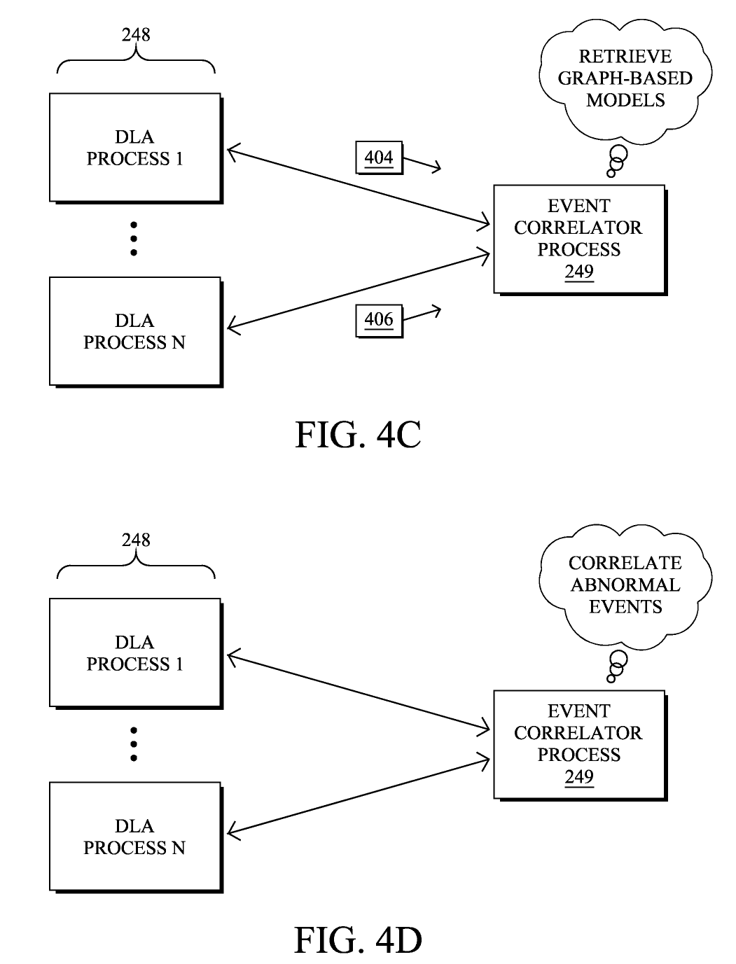

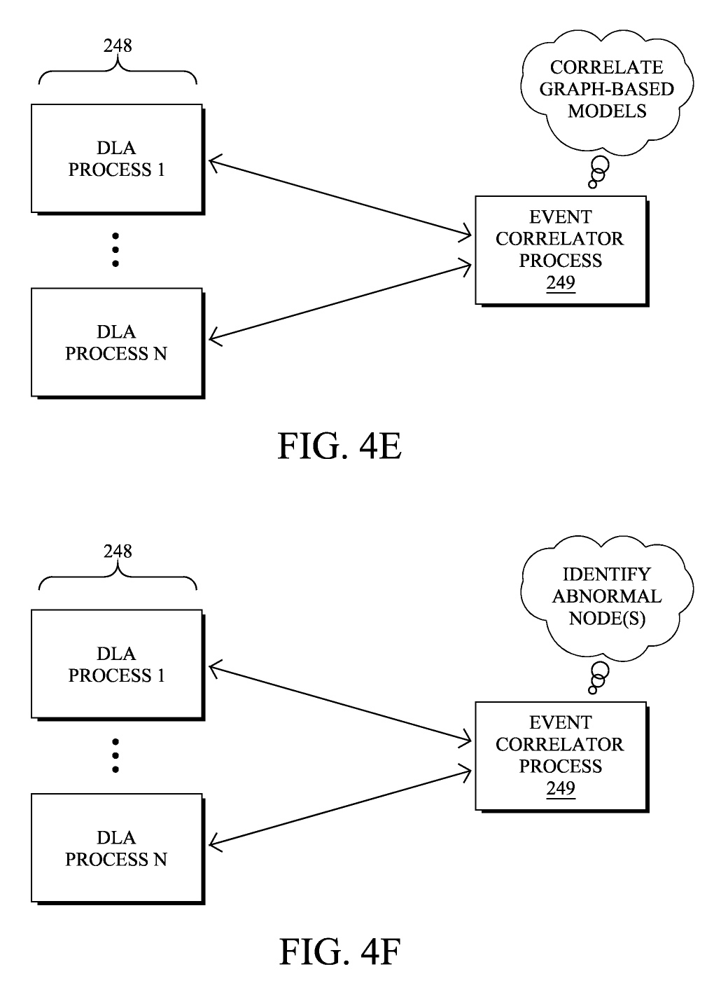

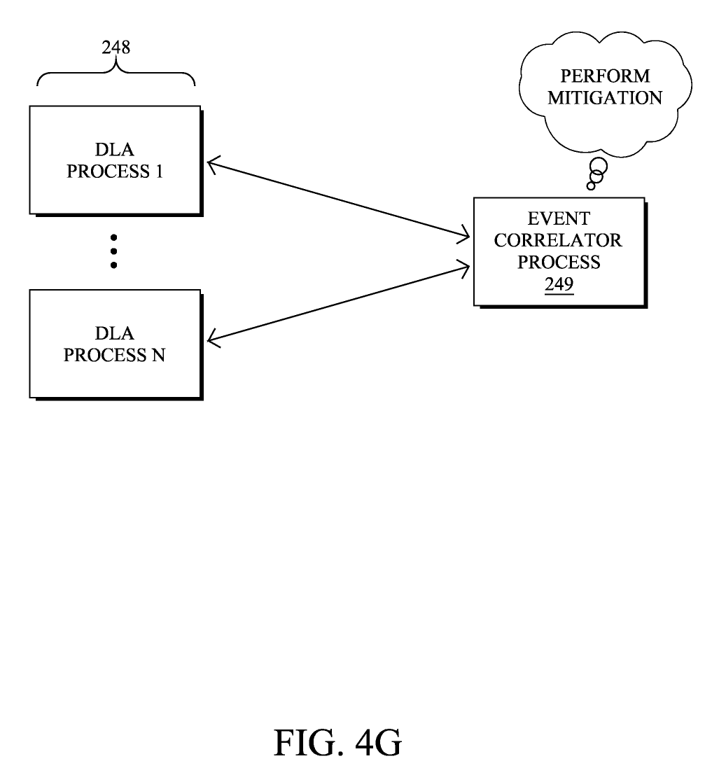

FIGS. 4A-4G illustrate an example architecture for detecting a network anomaly, according to various embodiments. As shown in FIG. 4A, any number of distributed devices in a network (e.g., a first through nth device) may host DLA process 248. In some embodiments, a given host may execute multiple DLA processes (e.g., to model and analyze different types of traffic flows, etc.). As noted previously, each of DLA processes 248 may generate a graph-based anomaly detection model (e.g., an ego-centric model, etc.) that models the OD of the hosting device.

A particular device hosting DLA process 248 that detects an anomaly in the network (e.g., a possible attack, etc.) may provide an indication of the detected anomaly to a supervisory/central network device. For example, assume that DLAᵢ shown detects an anomaly. In such a case, it may provide indication 402 to a supervisory device (e.g., a self learning network central agent in servers 152-154, etc.) that executes event correlator process 249. Indication 402 may include, in various embodiments, information regarding the type of flow(s) that were deemed anomalous (e.g., the flow source, the flow destination, the application ID, etc.), the type of detected anomaly, an anomaly score, a duration, or any other information regarding the detected anomaly. Indication 402 may provide such information in compressed form (e.g., as mathematical models) or as raw data, in various embodiments. In addition, indication 402 may be provided to the supervisory device on a push basis (e.g., in response to detecting the anomaly) or on a pull basis (e.g., in response to receiving a request for information regarding any anomalies detected by the DLA).

DLA process 248 may detect an anomaly either directly from a graph-based anomaly detection model or, alternatively, construct such a model in response to detecting an anomaly using another detection technique (e.g., statistical methods, etc.). Generally, anomalies may be detected from a graph-based model based on an assumption that the features of the graph (e.g., the degree of a node, the number of edges in the graph, the total edge weights in the graph, the principal eigenvalue of the weighted adjacency matrix for the graph, etc.) follow a power law and/or an expected pattern.

In some aspects, the supervisory device may confirm whether the detected anomaly is a true positive. For example, as shown in FIG. 4B, event correlator process 249 may determine whether the anomaly detected by DLA₁ is a true positive or a false positive. In some embodiments, the supervisory device may provide information regarding the detected anomaly to a user interface for confirmation by a network administrator. For example, the device may provide a webpage or other graphical user interface to a display that includes information regarding the detected anomaly (e.g., any of the information included in indication 402). In turn, the administrator may confirm whether the detected anomaly is a false positive or a true positive that is related to a known or unknown condition (e.g., the presence of malware in the network, etc.). In other embodiments, event correlator process 249 may itself be configured to confirm or deny a detected anomaly, based on one or more predefined rules.

If a detected anomaly is confirmed (e.g., by a user/administrator, based on predefined rules, etc.), event correlator process 249 may retrieve the graph-based models of the DLAs, as shown in FIG. 4C. For example, the supervisory device hosting event correlator process 249 may inspect its local database to search for all graph-based models retrieved by the device and computed by the set of DLAs in the network and/or request such models from the DLAs. Event correlator process 249 may use this data for purposes of anomaly correlation. In various embodiments, event correlator process 249 may initiate anomaly correlation automatically (e.g., based on the type of anomaly, etc.) or may do so in response to receiving a request to do so from a user interface device (e.g., the network administrator requests that anomaly correlation be performed).

Should the graph-based models stored by event correlator process 249 not be recent, the supervisory device may request an update from the corresponding DLAs. For example, DLA₁ may provide model data 404 to the supervisory device, DLAₙ may provide model data 406 to the supervisory device, etc. In yet further embodiments, the supervisory device may request the graph-based models from all DLAs belonging a specific domain using a well-know multicast IPv4/v6 address, specifying the model of interest (e.g., graph vs. host models, . . . ), etc. Note that in one embodiment, graph correlation may also be performed in batch-mode (e.g., during quiet periods) or in response to detecting the anomaly (e.g., as specified by policy, explicitly required by the administrator, etc.), according to the severity of the detected anomaly.

As shown in FIG. 4D, the supervisory device hosting event correlator process 249 may correlate events that occur in the network (e.g., detected abnormal events, etc.). Such an operation is not trivial and may allow for determining the root cause of an attack on the network (e.g., the attacking nodes, the control and command node in charge of a botnet, etc.). In particular, the supervisory device hosting event correlator process 249 may identify any events that may be correlated to the detected abnormality (e.g., events associated with other traffic flows or devices, etc.). In one embodiment, the supervisory device may first extract the set of traffic flows suspected to be the cause of the reported anomaly along with the source(s) and destination(s) associated with the flow(s). The supervisory device may also use this source/destination information to determine from which DLAs the supervisory device should retrieve graph-based models, as noted above (e.g., the DLAs that may partially or fully observe any of the abnormal traffic flows). For example, if the destination is a proxy-HTTP server, all sites hosting a DLA are potential hosts of similar malware. However, if the destination is also in the local network (e.g., the other extreme case), the supervisory device may decide to stop the correlation process since the anomaly is likely to be limited to the site/local network where both the source and destination associated with the anomaly reside. For example, in one embodiment, the supervisory device may determine whether a detected anomaly is localized by inspecting the routing tables advertised by that site and determine whether or not both the source and destination belong to the same site. Inspecting the routing tables (e.g., BGP) allows for determining the list of site(s) potentially hosting a compromised set of devices.

In a further aspect, the supervisory device executing event correlator process 249 may correlate multiple graph-based models retrieved from the various DLAs. In other words, event correlator process 249 may analyze the different graph-based models, to determine how similar the models are to the model associated with the abnormality (e.g., by measuring the degree of similarity between a set of graphs, using sub-graph matching, etc.). In various embodiments, event correlator process 249 may use different techniques to determine the degree of similarity/correlation between the different graph-based models, due to varying degrees of complexity. For example, if event correlator process 249 analyzes two graph-based models for non-overlapping networks, the search may be limited to finding the set of common IP addresses in the flows (e.g., as sources or destinations) marked as offending/anomalous flows. However, if event correlator process 249 analyzes two or more graph-based models hosted by DLAs on the same network, process 249 may find the set of anomalous/offending flows that overlap across the models, as shown in FIG. 4E. Such information may be used by event correlator process 249 to identify the potential source of an attack, which may be internal or external to the network, as shown in FIG. 4F. For example, the source of the attack could be a control and command (C&C) device controlling a set of malware or a specific host trying to access a set of remote servers, in which case the graph similarity/correlation may allow event correlator process 249 to extract the common destination for all abnormal flows reported by the DLAs and present in the graph-based models.

In further embodiments, event correlator process 249 may expand its search of the graph-based models from the DLAs to search for similar flows to those identified as anomalous (e.g., in addition to finding the anomalous/offending flows). Indeed, the control of a particular malware, for instance, will generate a particular structure of connections in a graph-based model, regardless of the C&C source. Therefore, once a C&C has been located, event correlator process 249 can use the information about the graph structure generated by this C&C to locate other C&Cs observed by other DLAs, but not labeled as abnormal yet. In one embodiment, these similar graph structures can be located using community-finding techniques. For instance, event correlator process 249 may extract graph-based features such as degrees of nodes, orders of sub-graphs, etc. and use a clustering technique such as k-means or DBSCAN on the feature space to locate similar graph structures. In other embodiments, event correlator process 249 may use pure graph structure techniques such as the clique percolation method, etc., to locate communities of similar graph structures. In yet another embodiment, event correlator process 249 may use a statistical inference technique to determine the similarity between graph-based models, such as those based on stochastic block models.

Once the cause of the detected anomaly has been identified, mitigation actions may be triggered in the network. For example, as shown in FIG. 4G, event correlator process 249 may cause one or more devices in the network to perform a mitigation operation, to alleviate the network anomaly/attack. Notably, although mitigation may be supported DLA devices individually, the degree of mitigation may be enhanced by event correlator process 249 in response to correlating anomalies across DLAs. For example, a flow may be flagged as abnormal, but still not terribly impacting, when observed in isolation by a DLA, thus not requiring drastic mitigation measures. However, if the correlation performed by event correlator process 249 reveals that the offending/abnormal flow is part of a more distributed attack, the mitigation may be more drastic, such as blocking the entire traffic from the source.

In one embodiment, event correlator process 249 may initiate mitigation by sending a custom unicast message to the DLA “hosting” the offending traffic that indicates that the flow is part of a generalized attack. Such a message may either specify the mitigation operation to be performed (e.g., by instructing the receiving device to shape traffic, to re-marking the traffic as low priority by re-coloring the DSCP fields, to drop the traffic, etc.) or the policy may be hosted on the DLA itself.

In another embodiment, event correlator process 249 may trigger a mitigation operation at a non-DLA device (e.g., a device that does not host DLA process 248). For example, assume that a network attack includes a number of attacking flows that traverse a particular non-DLA router (e.g., a C&C server outside of the network, etc.). In such a case, event correlator process 249 may send a custom message to the device, or to an NMS in charge of the configuration of the device, that includes an instruction to perform a specified mitigation operation. For example, event correlator process 249 may determine that a series of hosts present in a set of graph-based models are involved in similar anomalies (e.g., a set of hosts that are compromised by malware trying to exfiltrate information from a series of servers outside of the network, such as in a site interconnected to their respective site via BGP). In such a case, event correlator process 249 may identify the set of paths followed by all offending flows, to determine the BGP routers where the mitigation operation should be performed. For the sake of illustration, suppose that n hosts in domains D1 and D2 (e.g., domains interconnected via different routing domains such as OSPF areas) are attempting to exfiltrate information from a server S in a remote domain D3 interconnected via BGP. Thus, event correlator process 249 may determine that all attack flows transit through a common BGP peer, determine that the common peer should perform a mitigation operation, and instruct the peer to do so, accordingly.

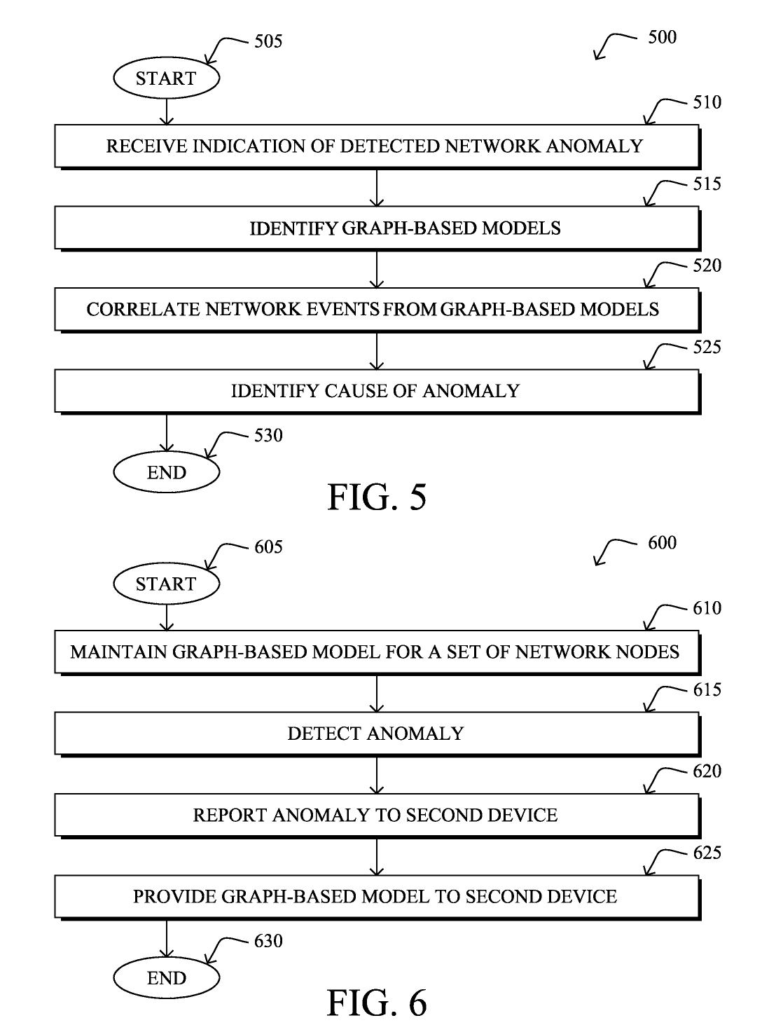

FIG. 5 illustrates an example simplified procedure for identifying the cause of a network anomaly using graph-based anomaly detection models, in accordance with various embodiments herein. Such a procedure may be used, in various implementations, to identify the cause of the anomaly using graph-based models maintained by distributed devices in the network. The procedure 500 may begin at step 505 and continue on to step 510 where, as described in greater detail above, a device in a network receives an indication of a detected network anomaly. Such an anomaly may, for example, indicate a potential attack on the network, failing or underperforming code, or any other condition that may negatively impact the operation of the network.

In various embodiments, the indication received by the device in step 510 may be provided by a first node in the network that hosts a graph-based anomaly detection model. Such a model may, for example, model the traffic or other relationships between a subset of nodes in the network that the first node is able to monitor. In other words, the graph-based model used by the first node may only model a subset of the network. In one embodiment, multiple nodes in the network may host similar graph-based models that each models a different subset of the network.

In response to receiving the indication of a detected network anomaly, the device may, in some embodiments, attempt to confirm that the detected anomaly is indeed anomalous and/or requires further action. In one embodiment, the device may provide data regarding the detected anomaly to a user interface device, to receive a confirmation or denial from a human operator. In another embodiment, the device may use a predefined set of rules to determine whether the detected anomaly is indeed anomalous and requires further action.

At step 515, the device identifies one or more additional graph-based anomaly detection models, as described in greater detail above. In various embodiments, the additional graph-based anomaly detection models may be hosted on the same node that detected the network anomaly or on different nodes (e.g., on different DLAs). The one or more additional graph-based anomaly detection models may be identified as the full set of deployed detection models (e.g., all models in the network) or a subset of the deployed models selected based on the detected network anomaly. For example, assume that the detected anomaly corresponds to a potential attack on a proxy-HTTP server. In such a case, the device may determine that all locations/sites hosting a DLA may also potentially host similar malware and identify the corresponding models from the DLAs.

At step 520, the device correlates network events associated with the graph-based anomaly detection models with the detected anomaly, as described in greater detail above. Said differently, the device may analyze the graph-based models from multiple distributed nodes in the network, to identify any similarities between the models. For example, the device may attempt to identify any common anomalies, traffic flows, sources, or destinations between the models. Correlation may be temporal (e.g., anomalies/events occurring within a certain amount of time of one another) and/or topographical (e.g., anomalies/events associated with the same device or set of devices). For example, assume that the detected anomaly in step 510 is an anomalous traffic flow directed to a particular device in the network. In such a case, one or more other traffic flows/anomalies from the other graph-based model(s) may be correlated to the detected anomaly. In addition to identifying any offending flows (e.g., anomalies) that are correlated to the anomaly, the device may, in some embodiments, be configured to also search for any traffic flows that are similar to the offending flows (e.g., flows to the same destination, flows containing similar traffic, etc.). In doing so, the device may expand its search to also identify any potentially offending traffic that was not previously identified as such by the individual models.

At step 525, the device identifies a cause of the anomaly, as described in greater detail above. Notably, the device may identify a set of one or more nodes and/or traffic flows that are potential causes of the anomaly based on the correlated events/anomalies from step 520. For example, in the case of a distributed network attack, the device may identify the nodes that are potentially infected with malware. In some embodiments, the device may also initiate mitigation actions based on the cause of the anomaly. For example, the device may cause one or more of the DLA-hosting nodes to perform an anomaly mitigation operation (e.g., dropping certain traffic, lowering the priority of certain traffic, etc.) and/or one or more non-DLA nodes to perform the mitigation operation. Procedure 500 then ends at step 530.

FIG. 6 illustrates an example simplified procedure for using a graph-based anomaly detection model, in accordance with various embodiments herein. Procedure 600 may be performed, in some embodiments, by a first device in a network that executes a DLA process (e.g., DLA process 248). As shown, procedure 600 may begin at step 605 and continue on to step 610 where, as described in greater detail above, the first device may maintain a graph-based model for a set of nodes in the network. Notably, such a model may represent the relationships between the various nodes over which the device has insight. For example, such a graph-based model may represent the various network nodes/devices as graph nodes and the traffic flows between the nodes/devices as graph edges. In some embodiments, the graph edges may be directional based on the traffic. In further embodiments, the graph edges may be weighted (e.g., based on the volume of the traffic flows). For example, in one embodiment, the first device may maintain one or more ego-centric graphs that represent nodes in the network. Such a model may only represent a subset of the devices in the network, in some cases.

At step 615, as detailed above, the device may detect an anomaly. In some cases, the device may detect the anomaly using the graph-based model itself. In these cases, the interrelationships between nodes, the edge weights, or other properties of a graph-based model may be indicative of an anomalous condition. For example, an excessively-weighted graph edge between nodes may indicate that the source node is attempting to maliciously overload the network and/or destination. In another example, the pattern of connections between nodes may be anomalous. In other embodiments, the device may detect the anomaly using another technique (e.g., statistical techniques, etc.) and generate/update the graph-based model, in response to detecting the anomaly.

At step 620, the first device reports the detected anomaly to a second device, as detailed above. In particular, the first device may provide an indication of the detected anomaly to a supervisory device responsible for determining whether any corrective measures should be taken in the network. For example, the supervisory device may validate the detected anomaly (e.g., by seeking validation by a human operator, according to predefined rules, etc.), prior to initiating any corrective measures. Such a report may, in some cases, identify any anomalous traffic flows, the source of the flow(s), the destination(s) of the flow(s), etc.

At step 625, as detailed above, the first device provides the graph-based model to the second device. In some embodiments, the first device may provide the graph-based model to the second device, in response to receiving a request for the information from the second device. For example, the second device may request the graph-based model after confirming the detected anomaly. In other embodiments, the first device may provide the graph-based model to the second device at predetermined times (e.g., periodically, at times when network usage is at a low, etc.). In these cases, the second device may still request the model if, for example, the second device determines that its stored model is potentially out of date. In some embodiments, the second device may use the reported anomaly and the model data to identify a cause of the anomaly and initiate an anomaly mitigation operation in the network. For example, the second device may instruct the first device to perform a mitigation operation (e.g., by blocking traffic, etc.), to alleviate the anomalous condition. Procedure 600 then ends at step 630.

It should be noted that while certain steps within procedures 500-600 may be optional as described above, the steps shown in FIGS. 5-6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 500-600 are described separately, certain steps from each procedure may be incorporated into each other procedure, and the procedures are not meant to be mutually exclusive.

The techniques described herein, therefore, provide for a self-learning network architecture that allows for distributed, graph-based models to detect anomalies in isolation, but do not have a global view of the network. Notably, the techniques herein allow for the correlation of detected anomalies/events at very low cost, thereby preserving the distributed nature of the anomaly detection architecture and allowing for anomaly mitigation to be initiated.

While there have been shown and described illustrative embodiments that provide for the correlation of distributed, anomaly detection models, it is to be understood that various other adaptations and modifications may be made within the spirit and scope of the embodiments herein. For example, the techniques herein may be adapted for use within any kind of anomaly detection, in addition to that of detecting potential network attacks and/or the presence of malicious software. Additionally, the protocols discussed herein are exemplary only and other protocols may be used within the scope of the teachings herein.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
receiving, at a device in a network, an indication of a network anomaly detected by a first graph-based anomaly detection model hosted by a first node in the network;
identifying, by the device, one or more additional graph-based anomaly detection models based on the network anomaly detected by the first graph-based anomaly detection model;
correlating, by the device, one or more network events from the one or more additional graph-based anomaly detection models with the network anomaly detected by the first graph-based anomaly detection model; and
identifying, by the device, a cause of the network anomaly using the one or more network events from the one or more additional graph-based anomaly detection models that are correlated with the network anomaly detected by the first graph-based anomaly detection model.

2. The method as in claim 1, wherein the network anomaly is indicative of an attack on the network.

3. The method as in claim 1, wherein the first graph-based anomaly detection model and the one or more additional graph-based anomaly detection models are hosted by different nodes in the network and model different subsets of the network.

4. The method as in claim 1, further comprising:
confirming, by the device, the network anomaly detected by the first node.

5. The method as in claim 1, wherein confirming the network anomaly detected by the first node comprises:
providing, by the device, information regarding the network anomaly detected by the first graph-based anomaly detection model to a user interface device; and
receiving, by the device, a confirmation via the user interface device that the network anomaly detected by the first graph-based anomaly detection model is anomalous.

6. The method as in claim 1, further comprising:
receiving, at the device, data regarding the first graph-based anomaly detection model from the first node and data regarding the one or more additional graph-based anomaly detection models from one or more other nodes in the network.

7. The method as in claim 6, further comprising:
requesting, by the device, the data regarding the first graph-based anomaly detection model from the first node and the data regarding the one or more additional graph-based anomaly detection models from the one or more other nodes in the network.

8. The method as in claim 1, wherein the one or more network events and the network anomaly are correlated temporally or topographically.

9. The method as in claim 1, wherein the device correlates the one or more network events with the network anomaly by:
identifying, by the device, one or more traffic flows from the one or more additional graph-based anomaly detection models and are associated with the detected network anomaly; and
identifying, by the device, a set of one or more nodes associated with the one or more traffic flows.

10. The method as in claim 1, wherein a particular one of the one or more network events correlated to the network anomaly is also a network anomaly detected by a particular one of the one or more additional graph-based anomaly detection models.

11. The method as in claim 1, further comprising:
causing, by the device, a particular node in the network to perform an anomaly mitigation operation, wherein the particular node is identified based on the cause of the network anomaly.

12. The method as in claim 11, wherein one or more traffic flows associated with the network anomaly flow through the particular node, and wherein the anomaly mitigation operation corresponds to the particular node blocking the one or more traffic flows associated with the network anomaly.

13. The method as in claim 11, wherein the particular node is the first node.

14. The method as in claim 11, wherein the particular node does not host a graph-based anomaly detection model.

15. The method as in claim 1, wherein the first graph-based anomaly detection model comprises an ego-centric graph that represents nodes in the network.

16. A method, comprising:
maintaining, at a first device in a network, a graph-based anomaly detection model for a set of nodes in the network;
detecting, by the first device, a network anomaly using the graph-based anomaly detection model;
reporting by the first device, the detected network anomaly to a second device; and
providing, by the first device, data regarding the graph-based anomaly detection model for the set of nodes to the second device.

17. The method as in claim 16, wherein the graph-based anomaly detection model comprises an ego-centric graph that represents the set of nodes.

18. The method as in claim 16, wherein the first device provides the data regarding the graph-based anomaly detection model to the second device in response to receiving a request for the data from the second device.

19. The method as in claim 16, further comprising:
receiving, at the first device, an instruction from the second device to perform an anomaly mitigation operation.

20. An apparatus, comprising:
one or more network interfaces to communicate with a network;
a processor coupled to the one or more network interfaces and configured to execute a process; and
a memory configured to store the process executable by the processor, the process when executed operable to:
receive an indication of a network anomaly detected by a first graph-based anomaly detection model hosted by a first node in the network;
identify one or more additional graph-based anomaly detection models based on the network anomaly detected by the first graph-based anomaly detection model;
correlate one or more events from the one or more additional graph-based anomaly detection models with the network anomaly detected by the first graph-based anomaly detection model; and
identify a cause of the network anomaly using the one or more network events from the one or more additional graph-based anomaly detection models that are correlated with the network anomaly detected by the first graph-based anomaly detection model.

21. The apparatus as in claim 20, wherein the network anomaly is indicative of an attack on the network.

22. The apparatus as in claim 20, wherein the first graph-based anomaly detection model and the one or more additional graph-based anomaly detection models are hosted by different nodes in the network and model different subsets of the network.

23. The apparatus as in claim 20, wherein the first graph-based anomaly detection model comprises an ego-centric graph that represents nodes in the network.

24. The apparatus as in claim 20, wherein the apparatus identifies the one or more network events correlated to the network anomaly by:
identifying one or more traffic flows from the one or more additional graph-based anomaly detection models and are associated with the network anomaly detected by the first node; and
identifying a set of one or more nodes associated with the one or more traffic flows.

25. The apparatus as in claim 20, wherein a particular one of the one or more network events correlated to the network anomaly is also a network anomaly detected by a particular one of the one or more additional graph-based anomaly detection models.

26. The apparatus as in claim 20, wherein the process when executed is further operable to:
cause a particular node in the network to perform an anomaly mitigation operation, wherein the particular node is identified based on the cause of the network anomaly.

27. An apparatus, comprising:
one or more network interfaces to communicate with a network;
a processor coupled to the one or more network interfaces and configured to execute a process; and
a memory configured to store the process executable by the processor, the process when executed operable to:
maintain a graph-based anomaly detection model for a set of nodes in the network;
detect a network anomaly using the graph-based anomaly detection model;
report the detected network anomaly to a device in the network; and
provide data regarding the graph-based anomaly detection model for the set of nodes to the device.

28. The apparatus as in claim 27, wherein the process when executed is further operable to:
receive an instruction from the second device to perform an anomaly mitigation operation.

29. The apparatus as in claim 27, wherein the graph-based anomaly detection model comprises an ego-centric graph that represents the set of nodes.
